(19) United States
(12) Patent Application Publication
(10) Pub. No.: US 2019/0265328 A1
(43) Pub. Date: Aug. 29, 2019

(54) POSITION ESTIMATION DEVICE AND POSITION ESTIMATION METHOD

(71) Applicant: Murata Manufacturing Co., Ltd., Kyoto (JP)

(72) Inventor: Tetsu NISHIMURA, Kyoto (JP)

(21) Appl. No.: 16/412,498

(22) Filed: May 15, 2019

Related U.S. Application Data
(63) Continuation of application No. PCT/JP2017/037577, filed on Oct. 17, 2017.

(30) Foreign Application Priority Data
Nov. 16, 2016 (JP) 2016-223128

(51) Int. Cl. G01S 5/14

(52) U.S. Cl. CPC G01S 5/14

(57) ABSTRACT

A position estimation device includes a calculator that calculates, in a mechanical system formed by connecting a hypothetical movable point and a plurality of receivers with a plurality of hypothetical springs, a position of the hypothetical movable point at which the plurality of hypothetical springs is in equilibrium as an estimated position of a mobile object, wherein the hypothetical spring corresponding to each of the plurality of receivers has a natural length that is a function of a distance from the receiver to the mobile object and has a smaller spring constant in contracted state than a spring constant in expanded state, the distance being based on the reception strength of a radio wave transmitted from the mobile object, the reception strength being measured by the receiver.

This is a continuation of International Application No. PCT/JP2017/037577 filed on Oct. 17, 2017 which claims priority from Japanese Patent Application No. 2016-223128 filed on Nov. 16, 2016. The contents of these applications are incorporated herein by reference in their entireties.

### BACKGROUND

### Technical Field

The present disclosure relates to position estimation devices and position estimation methods of a mobile object, and, in particular, a technique that estimates the position of a mobile object based on the reception strength of a radio wave, which is transmitted from the mobile object, at a plurality of fixed stations.

There is a technique called trilateration in which the position of a mobile object is determined by measuring respective distances to the mobile object from a plurality of fixed stations whose positions are known.

FIG. 1 is a diagram illustrating a basic concept of trilateration. As illustrated in FIG. 1, in trilateration, an intersection of three circles (hereinafter, referred to as existing circles) is determined as an estimated position of a mobile object. Here, the three circles are centered at a fixed station a, a fixed station b, and a fixed station c and have radii of a distance dₐ, a distance d_{b}, and a distance d_{c}, respectively, and the distance dₐ, the distance d_{b}, and the distance d_{c} are distances to the mobile object from the fixed station a, the fixed station b, and the fixed station c, respectively.

FIG. 2 is a diagram illustrating an example of the existing circles in actual trilateration. As illustrated in FIG. 2, in actual trilateration, a distance dₐ′, a distance d_{b}′, and a distance d_{c}′, which include errors, are used. Thus, three existing circles do not intersect at one point. Thus, there is a need for another idea to determine the estimated position of a mobile object at one point.

In the past, several methods have been proposed for determining the position of a mobile object at one point in actual trilateration (for example, Non Patent Document 1).

FIG. 3 is a diagram illustrating a basic concept of a mass-spring model disclosed in the Non Patent Document 1. As illustrated in FIG. 3, in the mass-spring model, a mechanical system is defined. This mechanical system is formed by connecting a hypothetical mass point and the fixed station a, the fixed station b, and the fixed station c with a hypothetical spring a, a hypothetical spring b, and a hypothetical spring c, whose natural distances are the distance dₐ′, the distance d_{b}′, and the distance d_{c}′, respectively. The position of the mass point corresponds to the position of a mobile object. Further, in the mechanical system, an equilibrium position of the springs is obtained, and the obtained equilibrium position is defined as an estimated position of a mobile object.

FIG. 4 is a graph indicating a characteristic of each of the spring a, the spring b, and the spring c to be used in the mass-spring model of the Non Patent Document 1, representing a relationship between a spring length 1 and an elastic force F. As illustrated in FIG. 4, in the Non Patent Document 1, the characteristic of each of the spring a, the spring b, the spring c is assumed to be a linear characteristic where the spring constant in contracted state is equal to the spring constant in expanded state. Note that the mass of mass point is set appropriately.

In the Non Patent Document 1, the distances to the mobile object from the fixed station a, the fixed station b, and the fixed station c are measured using Round-trip Time-of-flight (RTOF) of a radio wave. Further, the equilibrium position of the springs is obtained by calculating, using sequential computation, a numerical solution of an equation of motion describing a damping vibration of the mass point by introducing an appropriate viscous resistance in the mass-spring model.

As illustrated in FIG. 4, in the mass-spring model of the Non Patent Document 1, the spring a, the spring b, and the spring c respectively exert, on the mass point, elastic forces F proportional to differences between their natural lengths and their lengths at each time-step of the sequential computation (that is, distances between a current position of the mass point and the fixed station a, the fixed station b, and the fixed station c). The current position of the mass point is sequentially updated based on the mass of the mass point, a net force of the elastic forces of the spring a, the spring b, and the spring c, and the viscous resistance, thereby causing the current position of the mass point to move to the equilibrium position with repetition of the computation.

As a result, even in a case where the distance dₐ′, the distance d_{b}′, and the distance d_{c}′ include errors, the estimated position of the mobile object is determined at the equilibrium position of the spring a, the spring b, and the spring c.

Note that, in the present specification, the equilibrium position of the springs is not limited to a location where the net force of the springs is exactly zero. In a practical example, the equilibrium position may be the position of the mass point where the net force of the springs is equal to or less than a predetermined threshold value, and the predetermined threshold value may define an ending condition (convergence determination) of the sequential computation for calculating the position of the mass point.

Non Patent Document 1: Silvan Wehrli and Heinz Jackel, “Comparison of Positioning Algorithms for a RTOF Radar System based on Multipath Simulations”, 2011 International conference on indoor positioning and indoor navigation, http://ipin2011.dsi.uminho.pt/PDFs/Shortpaper/46_Short_Paper.pdf, (accessed on Sep. 3, 2016).

### BRIEF SUMMARY

The accuracy of the position of the mobile object estimated in the mass-spring model of the Non Patent Document 1 depends on the accuracy of the distance to the mobile object measured at each fixed station.

For example, in a case where a distance measurement method that enables stable measurement of relatively accurate distance, such as RTOF described in the Non Patent Document 1 and the like, is used, the position of a mobile object is estimated in a favorable and stable manner.

On the other hand, for example, in a case where a distance measurement method that is simple but include a larger measurement error, such as a method of measuring a distance to a mobile object based on the reception strength of a radio wave (for example, a beacon) transmitted from the mobile object, the position of a mobile object may not be estimated stably in some cases.

The present disclosure provides a position estimation device and a position estimation method that enable stable estimation of the position of a mobile object based on the reception strength of a radio wave transmitted from the mobile object at a plurality of fixed stations.

A position estimation device according to one aspect of the present disclosure includes a calculator that calculates, in a mechanical system formed by connecting a hypothetical movable point and a plurality of receivers with a plurality of hypothetical springs, a position of the hypothetical movable point at which the plurality of hypothetical springs is in equilibrium as an estimated position of a mobile object, the hypothetical spring corresponding to each of the plurality of receivers, having a natural length that is a function of a distance from the receiver to the mobile object, and having a spring constant that is smaller in contracted state than in expanded state, the distance being based on reception strength of a radio wave transmitted from the mobile object, the reception strength being measured by the receiver.

When the distances from fixed stations to a mobile object are measured based on the reception strength of a radio wave, the reception strength of the radio wave may sometimes decrease significantly at a certain fixed station from the original reception strength due to, for example, obstructions or fading. In such a case, the measured distance to the mobile object becomes significantly longer than the actual distance, and because an overlong natural length is set for the spring connected to the certain fixed station, a large error occurs in the equilibrium position of the springs.

On the other hand, according to the configuration of the present disclosure as described above, the spring whose spring constant in contracted state is smaller than in expanded state is used, unlike the configuration in which the spring constant in contracted state and the spring constant in expanded state are equal. That is, the spring exerts an expanding force (repulsive force) that is weaker than its contracting force (contractile force). Accordingly, even in the case where the reception strength of the radio wave at the certain fixed station decreases significantly and an overlong natural length is set for the spring connected to the certain fixed station, the repulsive force exerted by the spring is weakened, thereby reducing an error that occurs in the equilibrium position of the springs.

As a result, the position estimation device is provided which is capable of stably estimating the position of the mobile object based on the reception strength of the radio wave transmitted from the mobile object at a plurality of fixed stations.

Further, the calculator may set the natural length of the spring connected to each of the plurality of receivers at the distance from the receiver to the mobile object, the distance being based on the reception strength measured by the receiver, and set the spring constant of the spring at a positive value when a length of the spring is longer than the natural length and at practically zero when the length of the spring is equal to or shorter than the natural length.

According to this configuration, the spring exerts no substantial repulsive force. Thus, even in a case where the reception strength of the radio wave at a certain fixed station decreases significantly and an overlong natural length is set for the spring connected to the certain fixed station, the spring exerts no repulsive force. As a result, the position estimation device is provided which prevents a significant error from occurring in the equilibrium position of the springs and enables stable estimation of the position of the mobile object.

Further, the calculator may set the natural length of the spring connected to each of the plurality of receivers at a distance obtained by subtracting a predetermined value from a distance from the receiver to the mobile object, the distance from the receiver to the mobile object being based on the reception strength measured by the receiver, and set the spring constant of the spring at a positive value when a length of the spring is longer than the natural length and at practically zero when the length of the spring is equal to or shorter than the natural length.

Further, the positive value may be a first positive value when the length of the spring is longer than the distance measured and a second positive value when the length of the spring is longer than the natural length and is equal to or shorter than the distance measured, the second positive value being smaller than the first positive value.

The measured distance to the mobile object includes normal errors even when no significant error such as obstacles, fading, or the like occurs. In a case where the distance from each receiver to the mobile object is measured longer than the actual distance, existing circles, each of which is centered at each receiver and has a radius equal to the distance from the receiver to the mobile object, overlap one another. The mobile object is likely to be inside an overlapping region of the existing circles. However, in a case where no substantial repulsive force is exerted by the spring, the equilibrium position of the springs is obtained on the contour of the overlapping region and prevented from being obtained inside the overlapping region.

On the other hand, according to the configuration described above, the natural length of the spring is reduced to the length obtained by subtracting the predetermined value from the measured distance to the mobile object. Thus, the spring exerts a contractile force even inside the overlapping region of the existing circles. Accordingly, depending on the predetermined value, in a case where an error of the distance measurement is similar to normal ones, the equilibrium position can be obtained inside the overlapping region of the existing circles. On the other hand, in a case where an error of the distance measurement is significantly large, a repulsive force exerted by the spring, for which an overlong natural length is set, is neutralized, thereby enabling to avoid having a significant error in the equilibrium position of the springs.

Further, the calculator may set the natural length of the spring connected to each of the plurality of receivers at a distance from the receiver to the mobile object, the distance being based on the reception strength measured by the receiver, and set the spring constant of the spring at a positive value when a length of the spring is longer than a threshold value obtained by subtracting a predetermined value from the natural length and at practically zero when the length of the spring is equal to or shorter than the threshold value.

According to this configuration, until the spring is compressed to the length of the threshold value from the natural length, the spring exerts a repulsive force according to the spring constant equal to the spring constant in expanded state and loses its substantial repulsive force when the spring reaches the length of the threshold. Accordingly, depending on the threshold value, in a case where an error of the distance measurement is similar to normal errors, the equilibrium position identical to that of the prior art can be obtained. On the other hand, in a case where an error of the distance measurement is significantly larger than normal errors, a repulsive force exerted by the spring, for which an overlong natural length is set, is neutralized, thereby enabling to avoid having a significant error in the equilibrium position of the springs.

Further, the calculator may calculate a numerical solution of an equation of motion describing a damping vibration of the movable point in the mechanical system by sequential computation.

According to this configuration, the equilibrium position can be obtained in accordance with a common calculation method.

Further, a position estimation method according to one aspect of the present disclosure calculates, in a mechanical system formed by connecting a hypothetical movable point and a plurality of receivers with a plurality of hypothetical springs, a position of the hypothetical movable point at which the plurality of hypothetical springs is in equilibrium as an estimated position of a mobile object, the hypothetical spring corresponding to each of the plurality of receivers, having a natural length that is a function of a distance from the receiver to the mobile object, and having a spring constant that is smaller in contracted state than in expanded state, the distance being based on reception strength of a radio wave transmitted from the mobile object, the reception strength being measured by the receiver.

According to this configuration, the spring whose spring constant in contracted state is smaller than in expanded state is used, unlike the prior art configuration in which the spring constant in contracted state and the spring constant in expanded state are equal. That is, the spring exerts an expanding force (repulsive force) that is weaker than its contracting force (contractile force). Accordingly, even in a case where the reception strength of the radio wave at a certain fixed station decreases significantly and an overlong natural length is set for the spring to be connected to the certain fixed station, a repulsive force exerted by the spring is weakened, thereby reducing an error that occurs in the equilibrium position of the springs.

As a result, the position estimation method is provided which is capable of stably estimating the position of the mobile object based on the reception strength of the radio wave transmitted from the mobile object at a plurality of fixed stations.

The position estimation device and the position estimation method according to the present disclosure enable to obtain a position estimation device and a position estimation method that are capable of stable estimation of the position of a mobile object based on the reception strength of a radio wave transmitted from the mobile object at a plurality of fixed stations.

### BRIEF DESCRIPTION OF THE SEVERAL VIEWS OF THE DRAWINGS

FIG. 1 is a diagram illustrating a basic concept of trilateration.

FIG. 2 is a diagram illustrating an example of existing circles in actual trilateration.

FIG. 3 is a diagram illustrating a basic concept of a prior art mass-spring model.

FIG. 4 is a graph indicating a characteristic of a spring to be used in the prior art mass-spring model.

FIG. 5 is a conceptual diagram illustrating an example of a facility in which a position estimation device is installed.

FIG. 6 is a block diagram illustrating an example of a functional configuration of a position estimation device according to Embodiment 1.

FIG. 7 is a flowchart illustrating an example of operation of a position estimation device according to Embodiment 1.

FIG. 8 is a graph illustrating a concept of distance measurement based on the reception strength of a radio wave.

FIG. 9 is a diagram illustrating an influence of a distance measurement error on the prior art mass-spring model.

FIG. 10 is a graph indicating an example of a spring characteristic according to Embodiment 1.

FIG. 11 is a diagram illustrating an advantageous effect of position estimation according to Embodiment 1.

FIG. 12 is a graph indicating an example of a spring characteristic according to a modified example of Embodiment 1.

FIG. 13 is a diagram illustrating an example of existing circles overlapping one another.

FIG. 14 is a graph indicating an example of a spring characteristic according to Embodiment 2.

FIG. 15 is a diagram illustrating an advantageous effect of a position estimation according to Embodiment 2.

FIG. 16 is a graph indicating an example of a spring characteristic according to a modified example of Embodiment 2.

FIG. 17 is a graph indicating an example of a spring characteristic according to Embodiment 3.

FIG. 18 is a block diagram illustrating an example of a functional configuration of a position estimation device according to Embodiment 4.

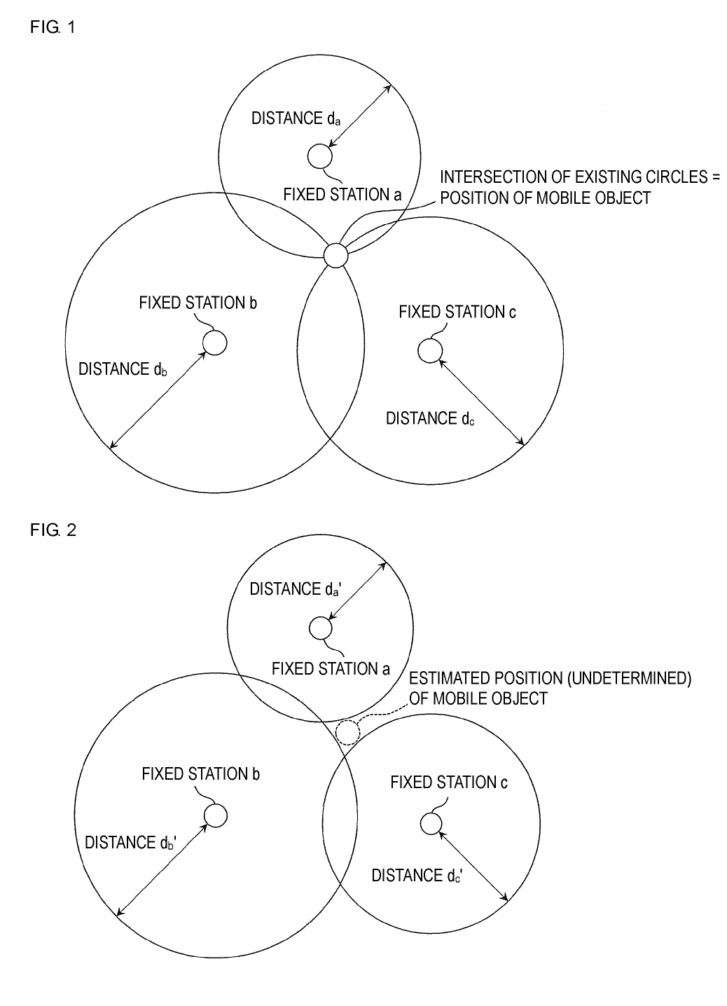

### DESCRIPTION OF EMBODIMENTS

Hereinafter, embodiments of the present disclosure will be described in detail with reference to the drawings. It should be noted that embodiments which will be described below each illustrate a comprehensive or specific example. Numeric values, shapes, materials, constituting elements, arrangements and connection modes of the constituting elements, steps, sequences of the steps, and the like are mere examples, and not intended to limit the present disclosure. Of the constituting elements in the following embodiments, constituting elements that are not described in an independent claim will be described as optional constituting elements. Further, dimensions or ratios of the dimensions of the constituting elements illustrated in the drawings are not necessarily exact.

### Embodiment 1

A position estimation device according to one embodiment is a device that measures the reception strength of a radio wave transmitted from a mobile object with a plurality of receivers installed at known positions that are different from each other and estimates the position of the mobile object based on the measured reception strength.

FIG. 5 is a conceptual diagram illustrating an example of a facility in which the position estimation device is installed. As illustrated in FIG. 5, a transmitter for transmitting a beacon is attached to a mobile object 20 whose position is to be detected inside the facility. Further, at predetermined positions inside the facility, fixed stations 100a to 100f that constitute the position estimation device are installed.

The fixed stations 100a to 100f are communicably connected to each other via a communication network, which is not illustrated. Each of the fixed stations 100a to 100f measures the reception strength of the beacon transmitted from the mobile object 20. Further, one representative fixed station (for example, fixed station 100a) acquires data representing the reception strength measured at a plurality of fixed stations via the communication network and estimates the position of the mobile object 20 based on the reception strength being represented by the data.

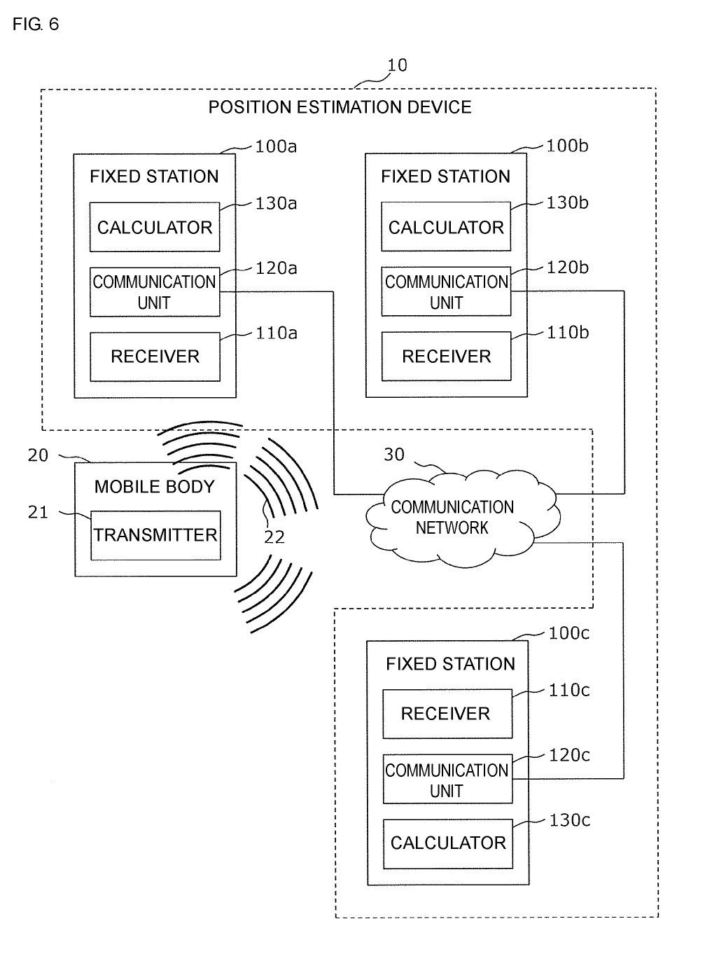

FIG. 6 is a block diagram illustrating an example of a functional configuration of a position estimation device according to Embodiment 1. In FIG. 6, for the sake of simplicity, only the fixed stations 100a, 100b, and 100c are illustrated as a position estimation device 10, and the mobile object 20 and a communication network 30 are illustrated together with the position estimation device 10.

A transmitter 21 for transmitting a beacon 22 is attached to the mobile object 20.

The transmitter 21 periodically transmits the beacon 22, which is a radio signal including identification information for identifying the mobile object 20, at a predetermined transmission strength. For example, the transmitter 21 may transmit the beacon 22 at every 0.1-1 second. The transmitter 21 may be, for example, an active RF tag to be used in radio frequency identifier (RFID). The transmitter 21 may alternatively be a radio device that transmits the beacon 22 in accordance with near field communication standards having excellent power-saving features, such as Zigbee (registered trademark) or Bluetooth (registered trademark) Low Energy.

The fixed stations 100a, 100b, and 100c have an identical configuration. Thus, only the fixed station 100a is described below. With regard to the fixed stations 100b and 100c, the letter “a” at the end of reference numerals described below is replaced with “b” and “c”, respectively.

The fixed station 100a includes a receiver 110a, a communication unit 120a, and a calculator 130a.

The receiver 110a is a radio device that operates in accordance with radio communication standards compatible with the transmitter 21. The receiver 110a receives the beacon 22 periodically transmitted from the transmitter 21 and measures the reception strength of the beacon 22 every time the receiver 110a receives the beacon 22.

The communication unit 120a is a communication device that communicably connects the fixed stations 100a, 100b, and 100c to each other via the communication network 30. The communication network 30 may be a wired or wireless network, and a communication device suitable for the communication network 30 is used as the communication unit 120a.

The communication unit 120a may be, for example, a network adapter connected to a wired local area network (LAN). The communication unit 120a may alternatively be a radio device that forms a wireless mesh network in accordance with near field communication standards having excellent power-saving features, such as Zigbee (registered trademark) or Bluetooth (registered trademark) Low Energy. In a case where the communication unit 120a performs radio communication in accordance with radio communication standards identical to the radio communication standards for the beacon 22, the communication unit 120a and the receiver 110a may share part or all of their constituting elements.

The calculator 130a acquires the reception strength of the beacon 22 measured by the receivers 110b and 110c via the communication unit 120a and estimates the position of the mobile object 20 based on the acquired reception strength and the reception strength of the beacon 22 measured by the receiver 110a.

The calculator 130a may be, for example, a one-chip microcomputer including a processor, a memory, an input/output port, and the like. The calculator 130a may acquire the reception strength of the beacon 22 and estimate the position of the mobile object 20 using software functions implemented by running programs, which are stored in the memory, on the processor.

Next, the operation of the position estimation device 10 configured as above is described.

In the position estimation device 10, each of the receivers 110a, 110b, and 110c measures the distance to the mobile object 20 based on the reception strength of the beacon 22. Subsequently, in a mechanical system formed by connecting a hypothetical movable point and the receivers 110a, 110b, and 110c with hypothetical springs corresponding to the respective receivers 110a, 110b, and 110c, the position of the hypothetical movable point at which these hypothetical springs are in equilibrium is calculated as an estimated position of the mobile object 20.

In the position estimation device 10, the mechanical system is represented in the form of, for example, an equation expressing a potential energy of the spring, an equation of motion describing a damping vibration of the movable point, a computation procedure for evaluating the equation or the equation of motion, and the like. The equation, the equation of motion, and the computation procedure described above include parameters such as the natural length of the spring, the spring constant, and the like, and are stored, for example, in the memory of the calculator 130a.

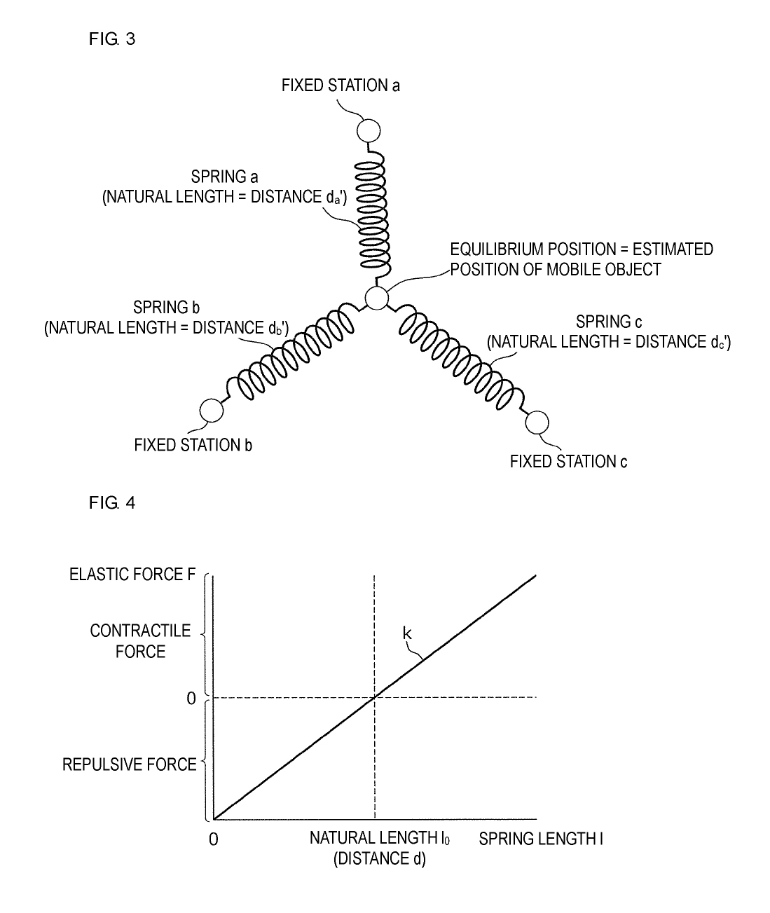

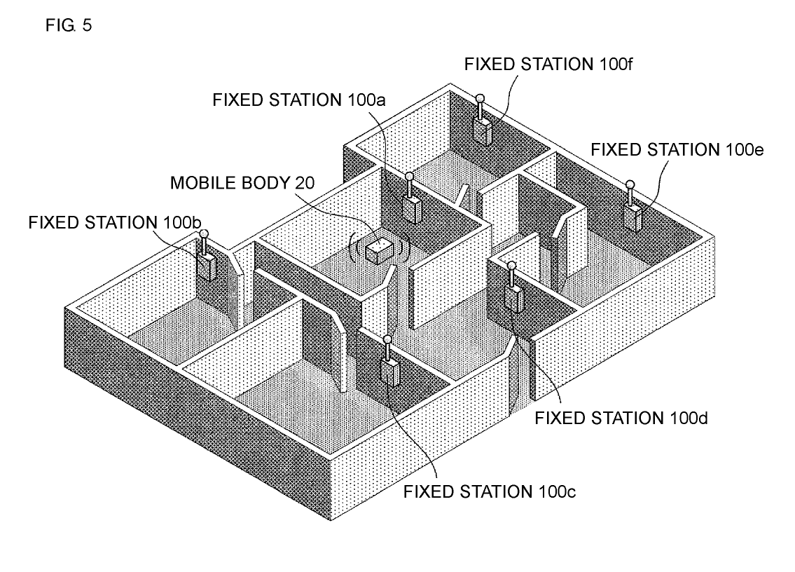

In the position estimation device 10, the spring corresponding to each receiver is characterized in that the spring has the natural length that is a function of the distance measured by the receiver and that the spring constant in contracted state is smaller than the spring constant in expanded state. Compared with the mass-spring model of the Non Patent Document 1 illustrated in FIG. 3 and FIG. 4, the mechanical system used in the position estimation device 10 has the identical spring connection mode but is different in that the spring constant of the spring in contracted state is smaller than the spring constant of the spring in expanded state.

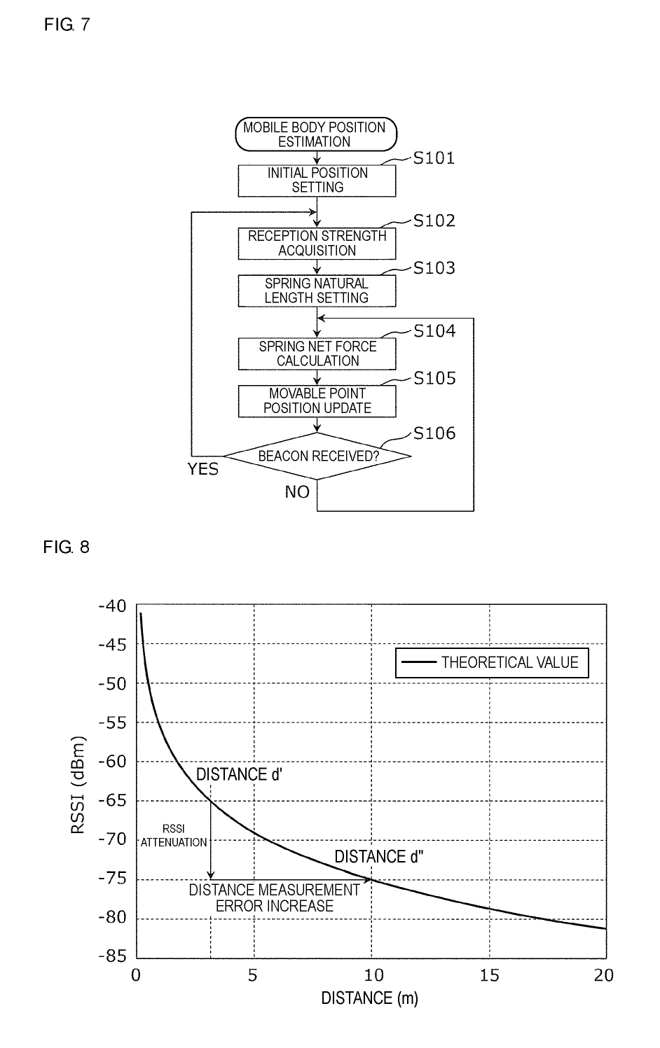

FIG. 7 is a flowchart illustrating an example of the operation of the position estimation device 10. FIG. 7 illustrates an example for obtaining, as the estimated position of the mobile object, the equilibrium point of the springs in the mechanical system described above by sequential computation.

The current position of the movable point is set as an initial position (S101). The initial position is arbitrary, and may be set, for example, at a point whose position is at equal distance from the fixed stations 100a, 100b, and 100c.

The reception strength of the beacon 22 is acquired (S102). The receivers 110a, 110b, and 110c receive the beacon 22 transmitted from the transmitter 21 at the same time and measure the reception strength of the beacon 22. The reception strength of the beacon 22 is expressed, for example, as a numeric value called Received Signal Strength Indicator (RSSI). The calculator 130a acquires the reception strength of the beacon 22 from each of the receivers 110a, 110b, and 110c directly or using the communication unit 120a.

The natural length of the spring is set (S103). Specifically, the distance to the mobile object 20 from each of the receivers 110a, 110b, and 110c is measured based on the reception strength of the beacon 22, and the natural length of each spring is set as a function of the distance measured at the receiver to which the spring is connected. Note that, specifically, the setting of the natural length of the spring means to set a parameter representing the natural length of the spring, which is included in the equation, the equation of motion, and the computation procedure, which are described above, and the like.

Now, a concept of the distance measurement based on the reception strength of a radio wave and an influence of a distance measurement error on the prior art mass-spring model are described.

FIG. 8 is a graph illustrating a concept of the distance measurement based on the reception strength of a radio wave. FIG. 8 illustrates an example of relationship between the distance and the theoretical value of reception strength, where the horizontal axis represents the distance from a receiver to a transmitter, and the vertical axis represents the reception strength (RSSI) of a beacon at the receiver, the beacon being transmitted from the transmitter at a predetermined transmission strength.

As illustrated in FIG. 8, for example, based on a RSSI measurement value of −65 dBm, the distance d′ to the transmitter is evaluated as about 3 meters. However, in some cases, even if the transmitter is located at the same position, the RSSI measurement value may decrease significantly due to obstacles, fading, or the like. For example, if the RSSI measurement value decreases to −75 dBm, the distance d″ to the transmitter is evaluated as about 10 meters, causing a large distance measurement error.

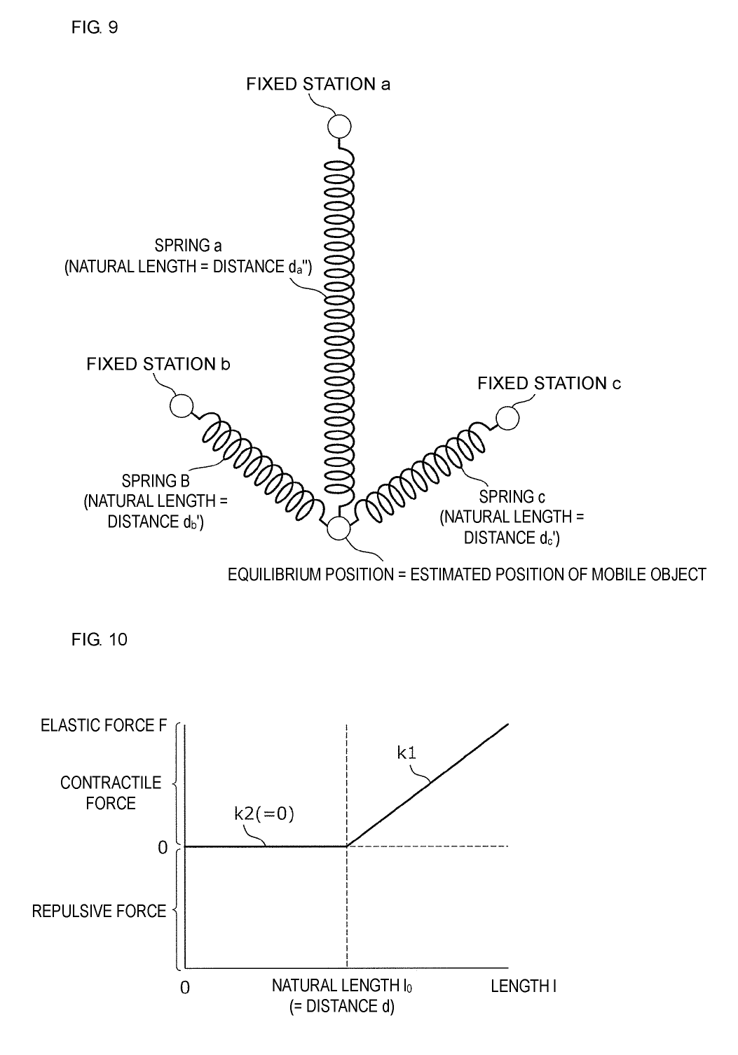

FIG. 9 is a diagram illustrating an influence of a distance measurement error on the prior art mass-spring model. The example of FIG. 9 assumes a case where, in the equilibrium state of FIG. 3, the RSSI measurement value at the fixed station a decreases and a significantly long natural length dₐ″ is set for the spring a. Setting of an overlong natural length for the spring a causes the spring a to be in a transitional state where the spring a is being contracted (not illustrated), generating a large repulsive force according to the spring characteristic illustrated in FIG. 4. As a result, the equilibrium position of the springs is pushed downward in FIG. 9, causing a large error to occur in the estimated position of the mobile object.

In view of the above, the position estimation device 10 uses the spring whose spring constant in contracted state is smaller than the spring constant in expanded state.

FIG. 10 is a graph indicating an example of the spring characteristic according to Embodiment 1. In the example of FIG. 10, the following spring characteristic is set for each spring. That is, the natural length lₒ of the spring connected to each receiver is set at a distance d from a receiver to the mobile object based on the reception strength measured at the receiver. Further, the spring constant of the spring is set at a positive value k1 when the length of the spring is longer than the natural length lₒ and is set at practically zero when the length of the spring is equal to or shorter than the natural length lₒ. For each spring, the spring characteristic is retained in the calculator 130a in the form of, for example, a function or a numerical table.

Returning to FIG. 7, the description regarding the operation of the position estimation device 10 based on the spring characteristic of FIG. 10 continues.

A net force of the springs is calculated (S104). Here, the net force is a vector quantity obtained by vector addition of elastic forces exerted by respective springs at their current lengths. The current length of each spring is a distance to the current position of the movable point from a fixed station to which the spring is connected. The elastic force exerted by each spring is an elastic force corresponding to the current length of the spring, which is represented by the spring characteristic (FIG. 10) of the spring.

The current position of the movable point is updated (S105). The current position of the movable point is moved in the direction of the net force of the springs calculated in the step S104.

By repeating the step S104 to the step S105, the current position of the movable point moves closer to the equilibrium position of the springs. In the step S104 to the step S105, specifically, a mass and a viscous resistance of the movable point may be appropriately introduced, and a numerical solution of an equation of motion describing a damping vibration of the movable point may be calculated by sequential computation.

When a new beacon is received (Yes in S106), the reception strength of the new beacon is acquired (S102), and the step S104 to the step S105 are repeated after resetting the natural length of the spring (S103).

FIG. 11 is a diagram illustrating an advantageous effect of the position estimation by the position estimation device 10. As illustrated in FIG. 11, for example, even in a case where the reception strength of the beacon decreases significantly at the fixed station 100a, and an overlong natural length dₐ″ is set for the spring a connected to the fixed station 100a, thereby causing the spring a to be in contracted state, the spring a does not exert any repulsive force. As a result, a significant error is prevented from occurring in the equilibrium position of the springs. This enables stable estimation of the position of the mobile object.

Note that, in order to have the foregoing advantageous effect, a spring constant k2 is not needed to be exactly zero.

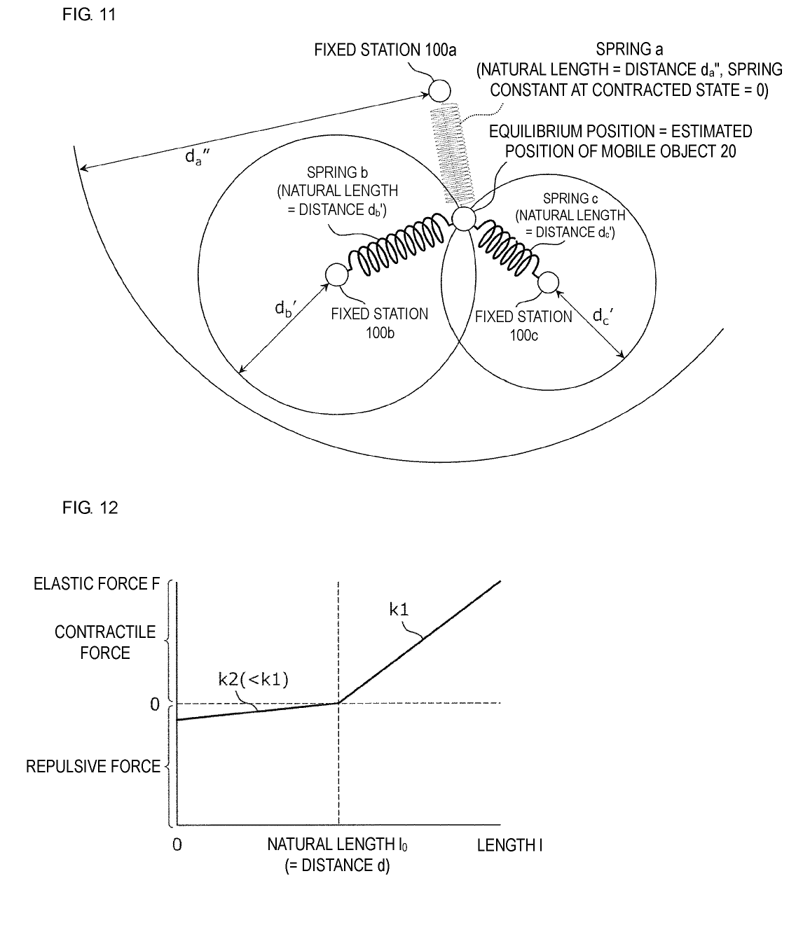

FIG. 12 is a graph indicating another example of the spring characteristic according to a modified example of Embodiment 1. In the example of FIG. 12, the spring constant k2 is set at a positive value smaller than the spring constant k1 (k2<k1), where the spring constant k2 is a spring constant when the length of the spring is equal to or shorter than the natural length l₀, and the spring constant k1 is a spring constant when the length of the spring is longer than the natural length l₀. By making the spring constant k2 smaller than the spring constant k1, a repulsive force exerted by the spring is weakened and an error that occurs in the equilibrium position of the springs is reduced even in the case where the reception strength of a radio wave at a fixed station decreases significantly and an overlong natural length is set for the spring connected to this fixed station.

### Embodiment 2

The measured distance to the mobile object always includes some errors even when no significant error such as obstacles, fading, or the like occurs. In a case where the distance from each receiver to the mobile object is measured slightly longer than the actual distance, existing circles overlap one another. Here, the existing circle is centered at each receiver and has a radius equal to the distance from the receiver to the mobile object.

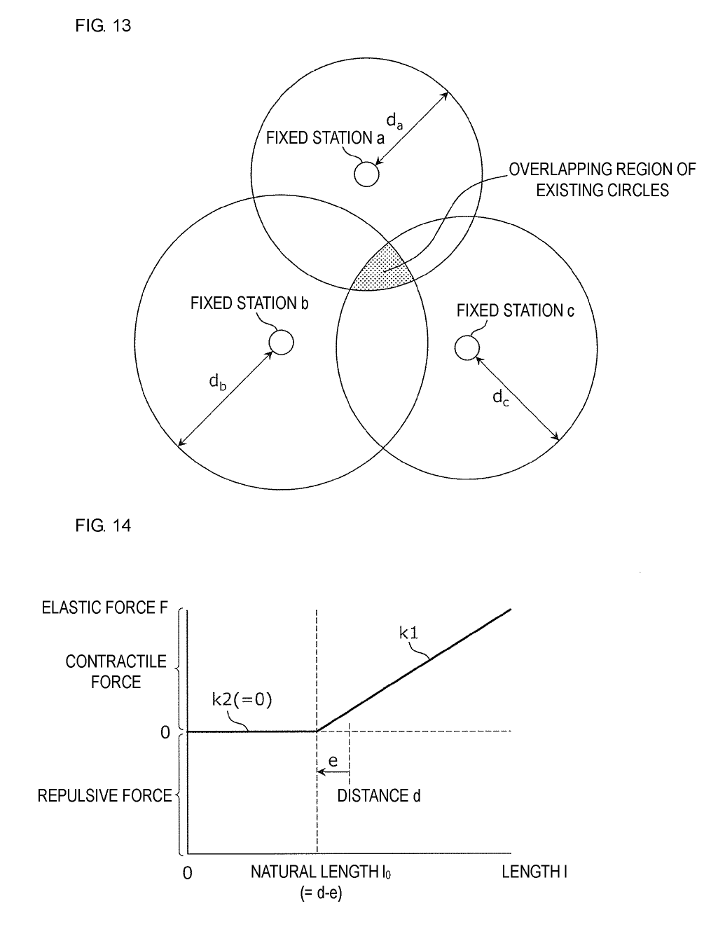

FIG. 13 is a diagram illustrating an example of the existing circles overlapping one another. The mobile object is likely to be inside an overlapping region where the existing circles overlap. However, if no substantial repulsive force is exerted by the spring when the spring is shorter than its natural length, the equilibrium position of the springs is obtained on the contour of the overlapping region and prevented from being obtained inside the overlapping region.

In view of the above, in Embodiment 2, the natural length of the spring is set at a distance obtained by subtracting a predetermined value from the measured distance to the mobile object.

FIG. 14 is a graph indicating an example of the spring characteristic according to Embodiment 2. In the example of FIG. 14, the following spring characteristic is set for each spring. That is, the natural length l₀ of the spring connected to each receiver is set at a distance obtained by subtracting a predetermined value e from the distance d, which is a distance to the mobile object based on the reception strength measured at each receiver. Further, the spring constant of this spring is set at a positive value k1 when the length of the spring is longer than the natural length l₀ and is set at practically zero when the length of the spring is equal to or shorter than the natural length l₀. For each spring, the spring characteristic is retained in the calculator 130a in the form of, for example, a function or a numerical table.

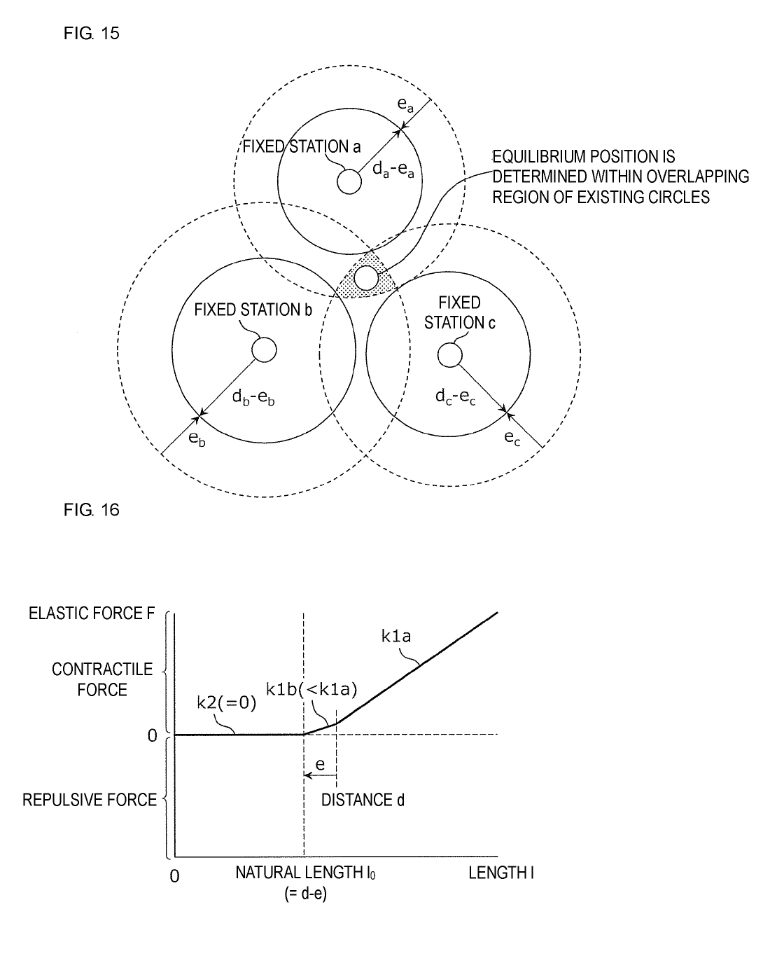

FIG. 15 is a diagram illustrating an advantageous effect of the position estimation that uses the spring characteristic of FIG. 14. As illustrated in FIG. 15, according to the spring characteristic of FIG. 14, the natural length of the spring is reduced by the predetermined value e from the measured distance d to the mobile object (that is, the radius of the existing circle). Accordingly, the spring exerts a contractile force in a circumference region having a width of the predetermined value e, even inside the existing circle.

As a result, depending on the predetermined value e, in a case where an error of the distance measurement is similar to normal ones, the equilibrium position can be obtained inside the overlapping region of the existing circles. On the other hand, in a case where an error of the distance measurement is significantly large, a repulsive force exerted by the spring, for which an overlong natural length is set, is neutralized, thereby enabling to avoid having a significant error in the equilibrium position of the springs.

In order to have this advantageous effect, the predetermined value e is appropriately determined based on sizes of normal errors included in the measured distances to the mobile object. Specifically, for example, for each fixed station, the predetermined value e may be a constant value between 1/10 and ½ inclusive of a distance from the fixed station to a nearest neighboring fixed station.

Note that, in the example described above, the spring constant is set at a single positive value k1 when the length of the spring is longer than the natural length lₒ. However, the spring constant is not limited to such example. For example, the spring constant may differ between when the length of the spring is longer than the measured distance d to the mobile object and when the length of the spring is equal to or shorter than the measured distance d to the mobile object.

FIG. 16 is a graph indicating an example of the spring characteristic according to a modified example of Embodiment 2. In the example of FIG. 16, the spring constant of the spring whose length is longer than the natural length lₒ is set at a first positive value k1a when the length of the spring is longer than the distance d and set at a second positive value k1b, which is smaller than the first positive value k1a, when the length of the spring is longer than the natural length lₒ and is equal to or shorter than the distance d.

According to the spring characteristic of FIG. 16, the equilibrium position of the springs can be optimized by weakening a contractile force exerted by the spring inside the existing circle, compared with a contractile force exerted by the spring outside the existing circle.

### Embodiment 3

In Embodiment 3, another spring characteristic that enables to obtain the equilibrium position of the springs inside the overlapping region of the existing circles is described.

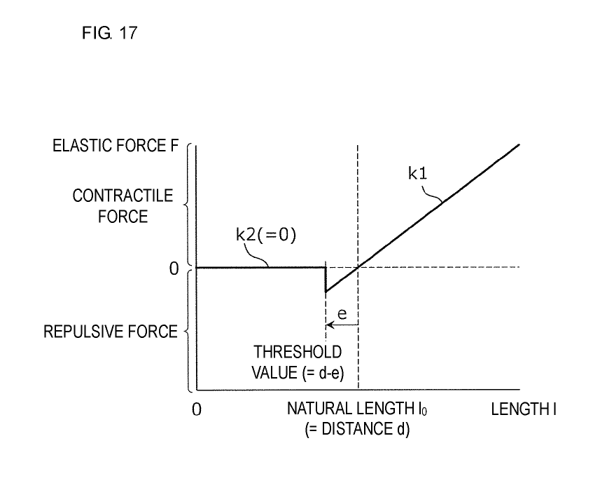

FIG. 17 is a graph indicating an example of the spring characteristic according to Embodiment 3. In the example of FIG. 17, the following spring characteristic is set for each spring. That is, the natural length lₒ of the spring connected to each receiver is set at a distance d from a receiver to the mobile object based on the reception strength measured at the receiver. Further, the spring constant of the spring is set at a positive value k1 when the length of the spring is longer than a threshold value d-e obtained by subtracting a predetermined value e from the natural length lₒ (=d), and is set at practically zero when the length of the spring is equal to or shorter than the threshold value d-e. For each spring, the spring characteristic is retained in the calculator 130a in the form of, for example, a function or a numerical table.

According to the spring characteristic of FIG. 17, the spring exerts a repulsive force in a circumference region having a width of the predetermined value e, even inside the existing circle.

As a result, depending on the predetermined value e, in a case where an error of the distance measurement is similar to normal ones, the equilibrium position identical to that of the prior art can be obtained. On the other hand, in a case where an error of the distance measurement is significantly large, a repulsive force exerted by the spring, for which an overlong natural length is set, is neutralized, thereby enabling to avoid having a significant error in the equilibrium position of the springs.

### Embodiment 4

In Embodiment 4, a position estimation device that performs the position estimation on a server is described.

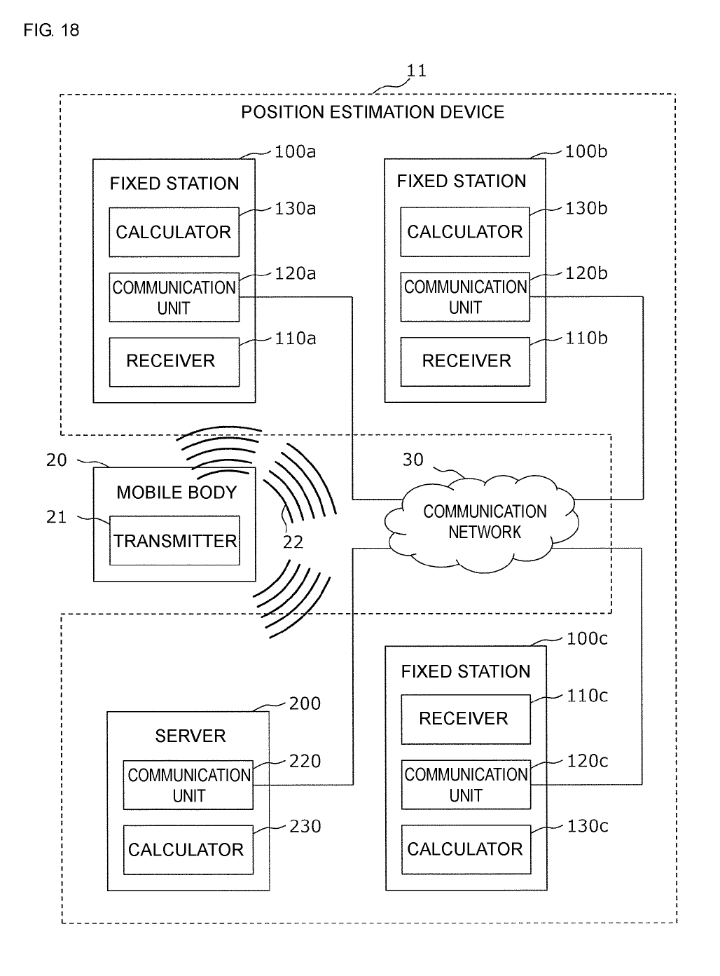

FIG. 18 is a block diagram illustrating an example of a functional configuration of the position estimation device according to Embodiment 4. As illustrated in FIG. 18, a position estimation device 11 is configured to include a server 200 in addition to the position estimation device 10 of FIG. 6.

The server 200 includes a communication unit 220 and a calculator 230.

The communication unit 220 is a communication device that communicably connects the server 200 and the fixed stations 100a, 100b, and 100c via the communication network 30.

The calculator 230 acquires the reception strength of the beacon 22 measured by the receivers 110a, 110b, and 110c via the communication unit 220, and estimates the position of the mobile object 20 based on the acquired reception strength.

The calculator 230 may be, for example, a general purpose computer formed by connecting a processor, a memory, and the like with a bus. The calculator 230 may acquire the reception strength of the beacon 22 and estimate the position of the mobile object 20 using software functions implemented by running programs, which are stored in the memory, on the processor.

The position estimation device 11 configured as above also performs the position estimation as is the case in the position estimation device 10.

Although the position estimation device and the position estimation method according to the embodiments of the present disclosure have been described above, the present disclosure is not limited to the individual embodiments. Embodiments obtained by applying various modifications apparent to those skilled in the art to the present embodiments and embodiments formed by combining constituting elements of different embodiments may be included in the scope of the one or more aspects as long as they do not depart from the scope of the present disclosure.

### INDUSTRIAL APPLICABILITY

The present disclosure can be widely used for position estimation of a mobile body such as, for example, position determination of goods and personnel in various facilities, position determination of wireless terminals in a cellular system, and the like.

### REFERENCE SIGNS LIST

10, 11 Position estimation device
20 Mobile object
21 Transmitter
22 Beacon
30 Communication network
100a-100f Fixed station
110a-110c Receiver
120a-120c Communication unit
130a-130c Calculator
200 Server
220 Communication unit
230 Calculator

1. A position estimation device for determining a position of a mobile object within a system comprising a plurality of receivers, the mobile object being represented as a hypothetical moveable point within the system connected to each of the plurality of receivers by a corresponding hypothetical spring, the device comprising:
a calculator configured to determine a position of the hypothetical movable point as a position at which the plurality of hypothetical springs are in equilibrium, the position of the hypothetical movable point being an estimated position of a mobile object,
wherein each hypothetical spring has a natural length that is a function of a distance from a corresponding receiver to the mobile object,
wherein a spring constant of each hypothetical spring in a contracted state is less than in an expanded state, and
wherein the distance from each receiver to the mobile object is based on a reception strength of a radio wave transmitted from the mobile object, the reception strength being measured by the receiver.

2. The position estimation device according to claim 1, wherein the calculator is further configured to:
determine the natural length of each hypothetical spring connected to the corresponding receiver as the distance from the corresponding receiver to the mobile object, the distance being based on the reception strength measured by the corresponding receiver, and
determine the spring constant of each hypothetical spring as a positive value when a length of the hypothetical spring is greater than the natural length, and as zero when the length of the hypothetical spring is equal to or less than the natural length.

3. The position estimation device according to claim 1, wherein the calculator is further configured to:
determine the natural length of each hypothetical spring as a difference between a predetermined value and the distance from the corresponding receiver to the mobile object, the distance from the corresponding receiver to the mobile object being based on the reception strength measured by the corresponding receiver, and
determine the spring constant of each hypothetical spring as a positive value when a length of the hypothetical spring is greater than the natural length, and as zero when the length of the hypothetical spring is equal to or less than the natural length.

4. The position estimation device according to claim 3, wherein the positive value is greater when the length of the hypothetical spring is greater than the distance, than when the length of the hypothetical spring is greater than the natural length and is also equal to or less than the distance.

5. The position estimation device according to claim 1, wherein the calculator is further configured to:
determine the natural length of each hypothetical spring as a distance from the corresponding receiver to the mobile object, the distance being based on the reception strength measured by the corresponding receiver, and
determine the spring constant of each hypothetical spring as a positive value when a length of the hypothetical spring is greater than a threshold value, and as zero when the length of the hypothetical spring is equal to or less than the threshold value,
wherein the threshold value is a difference between a predetermined value and the natural length the hypothetical spring.

6. The position estimation device according to claim 1, wherein the calculator is further configured to determine the position of the hypothetical movable point by determining a numerical solution of an equation of motion describing a damping vibration of the hypothetical movable point by sequential computation.

7. A position estimation method for determining a position of a mobile object within a system comprising a plurality of receivers, the mobile object being represented as a hypothetical moveable point within the system connected to each of the plurality of receivers by a corresponding hypothetical spring, the method comprising:
determining a position of the hypothetical movable point as a position at which the plurality of hypothetical springs are in equilibrium, the position of the hypothetical movable point being an estimated position of a mobile object,
wherein each hypothetical spring has a natural length that is a function of a distance from a corresponding receiver to the mobile object,
wherein a spring constant of each hypothetical spring in a contracted state is less than in an expanded state, and
wherein the distance from each receiver to the mobile object is based on reception strength of a radio wave transmitted from the mobile object, the reception strength being measured by the receiver.

8. The position estimation method according to claim 7, wherein:
the natural length of each hypothetical spring connected to the corresponding receiver is the distance from the corresponding receiver to the mobile object, the distance being based on the reception strength measured by the corresponding receiver, and
the spring constant of each hypothetical spring is a positive value when a length of the hypothetical spring is greater than the natural length, and is zero when the length of the hypothetical spring is equal to or less than the natural length.

9. The position estimation method according to claim 7, wherein:
the natural length of each hypothetical spring is a difference between a predetermined value and the distance from the corresponding receiver to the mobile object, the distance from the corresponding receiver to the mobile object being based on the reception strength measured by the corresponding receiver, and
the spring constant of each hypothetical spring is a positive value when a length of the hypothetical spring is greater than the natural length, and is zero when the length of the hypothetical spring is equal to or less than the natural length.

10. The position estimation method according to claim 9, wherein the positive value is greater when the length of the hypothetical spring is greater than the distance, than when the length of the hypothetical spring is greater than the natural length and is also equal to or less than the distance.

11. The position estimation method according to claim 7, wherein:
the natural length of each hypothetical spring is a distance from the corresponding receiver to the mobile object, the distance being based on the reception strength measured by the corresponding receiver,
the spring constant of each hypothetical spring is a positive value when a length of the hypothetical spring is greater than a threshold value, and is zero when the length of the hypothetical spring is equal to or less than the threshold value, and
the threshold value is a difference between a predetermined value and the natural length the hypothetical spring.

12. The position estimation method according to claim 7, further comprising determining the position of the hypothetical movable point by determining a numerical solution of an equation of motion describing a damping vibration of the hypothetical movable point by sequential computation.
